(19) United States
(12) Patent Application Publication
(10) Pub. No.: US 2025/0030620 A1
(43) Pub. Date: Jan. 23, 2025

(54) TRANSMISSION OF A MEASUREMENT RESULT THROUGH A PACKET-SWITCHED COMMUNICATION NETWORK

(71) Applicant: Telecom Italia S.p.A., Milano (IT)

(72) Inventor: Mauro COCIGLIO, Torino (IT)

(73) Assignee: Telecom Italia S.p.A., Milano (IT)

(21) Appl. No.: 18/714,921

(22) PCT Filed: Nov. 28, 2022
(86) PCT No.: PCT/EP2022/083404

§ 371 Date: May 30, 2024

(30) Foreign Application Priority Data
Dec. 1, 2021 (IT) 102021000030458

(51) Int. Cl. H04L 43/0864; H04L 43/026

(52) U.S. Cl. CPC H04L 43/0864; H04L 43/026

(57) ABSTRACT

It is disclosed a method for transmitting through a packet-switched communication network a measurement result (for example, an RTT measurement result) available at a node of the network. The node applies to packets to be transmitted to a further node of the network a marking value, which is switchable between two alternative marking values. The node performs a first switching of the marking value, then waits a wait whose duration is equal to a value indicative of the measurement result available at the node itself, and then performs a second switching of the marking value. A probe placed on the path of the marked packets detects the first and second switching in the packets, and obtains a reading of the measurement result available at the node as the time lapsing between them.

### TECHNICAL FIELD

The present invention relates to the field of communication networks. In particular, the present invention relates to a method for transmitting a measurement result available at a node of a packet-switched communication network (e.g. the result of a packet loss measurement, a delay measurement, a local temperature measurement, etc.) through the network itself.

### BACKGROUND ART

In a packet-switched communication network, packet flows are transmitted from source nodes to destination nodes through possible intermediate nodes. Exemplary packet-switched networks are IP (Internet Protocol) networks, Ethernet networks and MPLS (Multi-Protocol Label Switching) networks.

Typically, each node of the network has one or more measurement results locally available, which may be either obtained by the node itself (alone or in cooperation with other nodes) or which the node may receive from other entities of the network or cooperating with the network, such as another node or a network controller or manager.

Such measurement results may comprise for example the results of measurements of operational parameters of the node's hardware, such as its temperature. As another example, such measurement results may include the results of performance measurements relating to the connection between the node and another node of the network, such as outgoing and/or incoming packet transmission rate, packet loss, one-way delay, round-trip (RTT) delay, jitter, etc.

### SUMMARY OF THE INVENTION

The Applicant has noticed that, in some cases, the above measurement results may be inaccessible (or hardly accessible) to entities other the entity which manages the nodes.

For example, client-server protocols, such as QUIC or TCP, typically provide that the nodes acting as endpoints of the client-server connection have available the results of RTT measurements, which are obtained (e.g. by the endpoints themselves) from encrypted packets and respective acknowledge encrypted packets exchanged by the endpoints. If an entity other than the one that manages the endpoints and the exchange of encrypted packets has no access to the RTT measurement results available at the endpoints and has no knowledge of the encryption parameters, it cannot obtain the RTT measurements, since it is not capable of autonomously decrypting and properly correlating the encrypted packets.

However, the results of such RTT measurements (as well as of other measurements locally available at the nodes) may be useful also to entities other than the one which manages the nodes.

In view of the above, the Applicant has tackled the problem of providing a method for transmitting a measurement result available at a node of a packet-switched communication network through the network itself so that, for instance, an entity having no direct access to the measurement result available at the node may read the measurement result as transmitted through the network.

According to embodiments of the present invention, this problem is solved by a method for transmitting a measurement result available at a node of a packet-switched communication network, wherein the node applies a marking value to packets of a packet flow transmitted from the node itself to another node. The marking value is switchable by the node between at least two alternative marking values. The node performs a first switching of the marking value applied to the packets, then waits a wait time whose duration is equal to a value indicative of the measurement result available at the node, and then performs a second switching of the marking value applied to the packets to be transmitted.

This operation of the node advantageously enables an entity having no direct access to the measurement result available at the node to read the measurement result available at the node from the packets transmitted by the node itself.

Assuming that the node (for example, the node acting as client of a QUIC connection) stores a value V_{I} indicative of an RTT measurement result e.g. performed by the node itself (for example, the result of the last RTT measurement performed), and that the marking value which the node applies to the packets to be transmitted is switchable e.g. between the marking values 0 and 1, the node performs a first switching of the marking value applied to the packets to be transmitted to the other node e.g. from 0 to 1. The node then waits a wait time whose duration is equal to V_{I}, during which it does not perform any further switching of the marking value applied to the packets to be transmitted. When the wait time whose duration is equal to V_{I} lapses, the node then performs a second switching of the marking value applied to the packets to be transmitted back from 1 to 0.

A probe placed on the path of the packet flow (namely, at an intermediate position or at any one of the two nodes) may then detect, in the packets transmitted from the node to the other node, the first switching from 0 to 1 and the second switching from 1 to 0 of the marking value applied by the node. The probe may then obtain a reading V_{E} of the RTT measurement result available at the node as the time lapsing between the detection times of the first and second switching of the marking value applied by the node, which is roughly equal to V_{I} (short of an error E, as it will be discussed in detail herein below).

Hence, even if the probe is implemented and operated by an entity other than the entity managing the nodes and, accordingly, has no direct access to the results of the RTT measurements available at the node, it is nonetheless enabled to indirectly obtain a reading V_{E} of the measurement result available at the node.

According to a first aspect, the present invention provides a method for transmitting through a packet-switched communication network a measurement result available at a node of the packet-switched communication network, the node applying a marking value to packets of a packet flow to be transmitted to a further node of the packet-switched communication network, the marking value being switchable by the node between at least two alternative marking values, the method comprising, by the node:
a) performing a switching of the marking value applied to packets of the packet flow to be transmitted to the further node;
b) waiting a wait time whose duration is equal to a value indicative of the measurement result available at the node; and
c) performing a further switching of the marking value applied to packets of the packet flow to be transmitted to the further node.

For example, the value indicative of the measurement result available at the node may be is equal to a round-trip time measurement result available at the node.

Preferably, step a) is performed when a first valid, non-zero measurement result is available at the node, and steps b) and c) are cyclically iterated after step a) has been performed.

Preferably, the wait time is started when a first packet of the packet flow following to the switching at step a) is transmitted to the further node.

Preferably, the value indicative of the measurement result available at the node is updated during step b) into an updated value indicative of an updated measurement result available at the node.

According to an embodiment, at step b) the duration of the wait time is kept equal to the stored value until lapse of the wait time, the updated value being applied at a subsequent iteration of step b).

According to another embodiment, at step b) the duration of the wait time is changed into the updated value while the wait time is ongoing.

According to a variant, the further switching at step c) comprises switching the marking value applied to packets of the packet flow to be transmitted to the further node only if a time lapsing between lapse of the wait time and subsequent transmission of a packet of the packet flow to the further node does not exceed a predefined time threshold.

Preferably, the further switching at step c) comprises forcing the further switching of the marking value applied to packets of the packet flow to be transmitted to the further node when a maximum time Tmax has lapsed since the switching at step a).

Preferably, the maximum time Tmax is higher than a maximum measurable value indicative of a maximum measurement result.

According to an embodiment, step a) comprises, after the switching, keeping the marking value applied to packets of the packet flow to be transmitted to the further node fixed, until the wait time is lapsed.

According to another embodiment, step a) comprises, after the switching, transmitting one packet of the packet flow to the further node, switching again the marking value applied to packets of the packet flow to be transmitted to the further node and keeping the marking value applied to packets of the packet flow to be transmitted to the further node fixed, until the wait time is lapsed.

According to a second aspect, the present invention provides a method for reading a measurement result available at a node of a packet-switched communication network and transmitted through the packet-switched communication network, the method comprising the steps of the method as set forth above and:
d) by a probe placed on a path of the packet flow, detecting a first switching and a second switching of the marking value applied to packets of the packet flow transmitted by the node to the further node and obtaining a reading of the measurement result available at the node as a time lapsing between the first switching and the second switching.

Preferably, step d) comprises discarding the reading if it is determined that the reading is not lower than the maximum time Tmax. According to a third aspect, the present invention provides a node for a packet-switched communication network, the node being configured to transmit a packet flow to a further node of the packet-switched communication network, the node being configured to apply a marking value to packets of the packet flow to be transmitted to the further node, the marking value being switchable by the node between at least two alternative marking values, the node being configured to:
a) perform a switching of the marking value applied to packets of the packet flow to be transmitted to the further node;
b) wait a wait time whose duration is equal to a value indicative of a measurement result available at the node; and
c) perform a further switching of the marking value applied to packets of the packet flow to be transmitted to the further node.

According to a fourth aspect, the present invention provides a packet-switched communication network comprising a node and a further node, the node being configured to transmit a packet flow to the further node, the node being as set forth above.

Preferably, the packet-switched communication network further comprises a probe placed on a path of the packet flow, the probe being configured to:
d) detect a first switching and a second switching of the marking value applied to packets of the packet flow transmitted by the node to the further node and obtaining a reading of the measurement result available at the node as a time lapsing between the first switching and the second switching.

### BRIEF DESCRIPTION OF THE DRAWINGS

The present invention will become clearer from the following detailed description, given by way of example and not of limitation, to be read with reference to the accompanying drawings, wherein:

FIG. 1 schematically shows a packet-switched communication network in which the method for transmitting a measurement result according to embodiments of the present invention is implemented;

FIG. 2 schematically shows the structure of a packet exchanged in the communication network of FIG. 1, 1 according to embodiments of the present invention;

FIG. 3 is a flow chart of the operation of a node of the communication network of FIG. 1, according to an embodiment of the present invention; and

FIG. 4 shows the transmission of an exemplary RTT measurement result though the communication network of FIG. 1.

### DETAILED DESCRIPTION OF PREFERRED EMBODIMENTS OF THE INVENTION

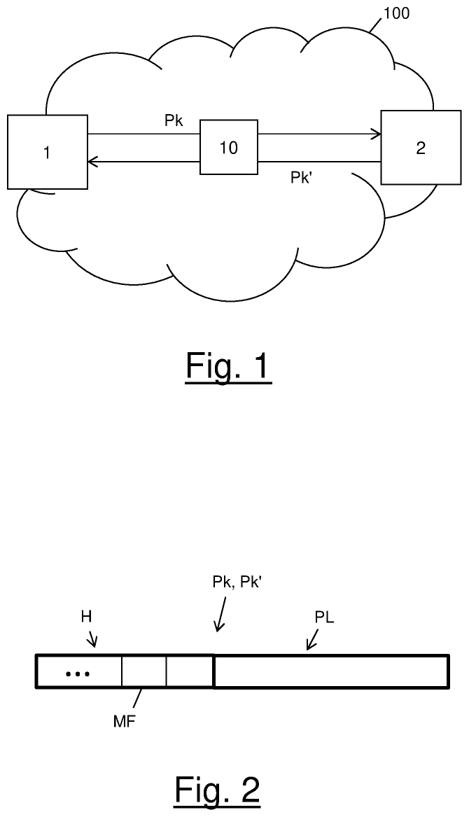

FIG. 1 schematically shows a packet-switched communication network 100 in which the method for transmitting a measurement result according to embodiments of the present invention is implemented.

The communication network 100 comprises a plurality of nodes reciprocally interconnected by physical links according to any known topology, including two nodes 1 and 2 shown in FIG. 1. The nodes 1 and 2 may be connected by a single physical link or by the concatenation of several physical links and intermediate nodes (not shown in the drawings). The communication network 100 may be for instance an IP network.

The nodes 1, 2 exchange a packet flow including packets Pk transmitted from the node 1 to the node 2. Optionally, the packet flow may be bidirectional and comprise also packets Pk′ transmitted from the node 2 to the node 1, as schematically depicted in FIG. 1. The packets Pk may belong to a same packet flow (namely, they may all have a same source address and a same destination address, e.g. a same IP source address and a same IP destination address) or to different packet flows whose paths are overlapping between the nodes 1 and 2. Similarly, the packets Pk′ may belong to a same packet flow or to different packet flows whose paths are overlapping between the nodes 2 and 1.

The packets Pk, Pk′ are formatted according to a certain network protocol. By way of non-limiting example, the network protocol may be the above mentioned QUIC protocol.

In particular, as schematically depicted in FIG. 2, each packet Pk, Pk′ comprises a payload PL comprising user data and at least one header H. In case of multiple headers, each header pertains to a different network layer. For example, each packet Pk, Pk′ may comprise a network layer header (such as an IP header) and transport layer header (such as a QUIC+UDP header or a TCP header). One of the headers H (typically, the network layer header) comprises packet forwarding information, namely information allowing the packets Pk to reach the network node 2 and the packets Pk′ to reach the node 1.

Each packet Pk, Pk′ also preferably comprises at least one dedicated, non-encrypted field MF (also termed herein after “marking field”) supporting transmission of a measurement result according to embodiments of the present invention. The marking field(s) MF may be comprised in the same header H as the packet forwarding information (as shown in FIG. 2), in a different header (if any) or in the payload PL. Assuming for example that the packets Pk, Pk′ comprise a network layer header (such as an IP header) and a transport layer header (such as a QUIC header), the marking field(s) MF may be comprised in the transport layer header. The marking field MF comprises one or more bits, preferably a single bit. The marking field MF may be set to anyone of two alternative marking values M1 and M2 (e.g. M1=0 and M2=1). By way of non-limiting example, if the packets Pk, Pk′ are formatted according to the QUIC protocol, the marking field MF may be a bit other than the spin bit comprised in the QUIC header as by B. Trammel et al.: Internet draft “The addition of a Spin Bit to the QUIC Transport Protocol draft-trammel-quic-spin-01”, Dec. 13, 2017.

At least one of the nodes 1, 2 sets the value of the marking field MF in its respective outgoing packets Pk, Pk′, before transmitting them to the other node 2, 1, so as to write a measurement result available at the node 1, 2 itself in its outgoing packets Pk, Pk′. By way of non-limiting example, it is assumed that only the node 1 sets the value of the marking field MF in its respective outgoing packets Pk, before transmitting them to the other node 2, so as to write a measurement result available at the node 1 itself in its outgoing packet Pk. The marking value which the node 1 applies to the packets Pk to be transmitted to the other node 2 will be also termed herein after “applicable marking value”. The applicable marking value is preferably switchable by the node 1 between the at least two alternative marking values M1 and M2 (for example, M1=0 and M2=1).

The measurement result available at the node 1 may be for example a performance measurement result, such as an RTT measurement result obtained (by the node 1 itself, or by another entity which provided the measurement result to the node 1) from encrypted packets and respective acknowledge encrypted packets exchanged between the nodes 1 and 2. Hence, if an entity has no access to the RTT measurement result available at the node 1 and has no knowledge of the encryption parameters, it cannot obtain any RTT measurement, since it is not capable of autonomously decrypting and properly correlating the encrypted packets.

The measurement result available at the node 1 may be the result of either a single measurement or multiple measurements. For example, the measurement result may be the result of the last measurement obtained by or provided to the node 1, or an average of the last N measurements obtained by or provided to the node 1.

Preferably, the node 1 determines and stores a value V_{I} indicative of the measurement result. The expression “indicative of” means that a predefined mathematical relationship exists between the measurement result and the value V_{I}, which enables the node 1 to calculate the value V_{I} starting from the available measurement result. For example, in case of an RTT measurement result, the predefined relationship may be an identity relationship, meaning that the value V_{I} is set equal to the RTT measurement result available at the node 1. For other types of measurement results (packet loss, jitter, local temperature, etc.), the predefined mathematical relationship may be for example a direct proportionality relationship of the type V_{I}=k (measurement result), where the proportionality factor k depends on the type of measurement result (measurement unit and order of magnitude of its numerical value). For example, in case of a temperature measurement, the proportionality factor k may be chosen so that one degree corresponds to e.g. 10 ms. In case of packet loss measurements or other measurements expressed in terms of percentage (%), instead, the proportionality factor k may be chosen so that 10% corresponds to e.g. 0.1 second. And so on. It shall be noticed that the mathematical relationship between the measurement result and the value V_{I} may also be non-linear, for example exponential or logarithmic. As another example, the possible values of the measurement results may be mapped into a discrete set of possible values V_{I1}, V_{I2} . . . . V_{IN}.

Once the value V_{I} has been determined and is stored by the node 1, according to embodiments of the present invention, the node 1 performs a first switching of the marking value applied to the packets Pk to be transmitted to the node 2, then waits a wait time whose duration is equal to the stored value V_{I} and then, upon lapse of the wait time, it performs a second switching of the marking value applied to the packets Pk to be transmitted to the node 2.

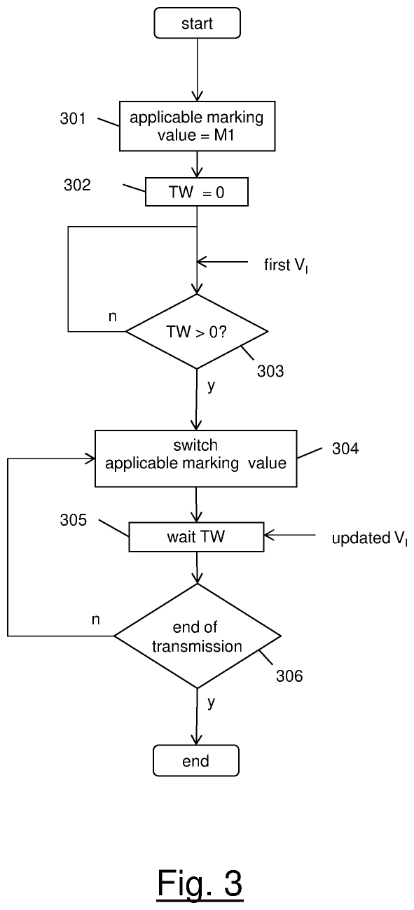

With reference now to the flow chart of FIG. 3, the operation of the node 1 according to an embodiment of the present invention will be described in further detail. If the nodes 1, 2 are the endpoints of a QUIC connection, the node 1 may be, for example, the one acting as client of the QUIC connection, while the node 2 may be, for example, the one acting as server of the QUIC connection.

The node 1 may be initialized with a first value M1 of its applicable marking value (step 301). This way, the node 1 starts transmitting to the node 2 packets Pk with their marking field MF set to the marking value M1 (e.g. M1=0).

Further, a local variable TW at the node 1 is preferably initialized to zero (step 302).

The node 1 preferably monitors (substantially continuously or periodically) the value of the local variable TW (step 303) and, as long as it continues being equal to zero, it preferably keeps its applicable marking value equal to M1.

When the node 1 is provided with or obtains a first valid, non-zero measurement result (e.g. an RTT measurement result), it determines the value V_{I} as described above and preferably writes it in the local variable TW, which accordingly becomes different from (in particular, higher than) zero.

When the node 1 realizes that the local variable TW has become higher than 0, it preferably switches its applicable marking value (step 304). Hence, the node 1 transmits to the node 2 one or more packets Pk with their marking field MF set to M2 (e.g. M2=1).

According to a first variant, all the packets Pk transmitted following to the switching step 304 have their marking field MF set to the same marking value (namely, M2 at the first iteration of step 304), until the next iteration of step 304. According to a second variant, instead, after transmitting a single packet Pk with its marking field MF set to M2, the node 1 switches its applicable marking value back to M1. Hence, while according to the first variant each iteration of the switching step 304 triggers the transmission of a block of packets with their marking fields MF set to a same marking value (namely M2 at the first iteration, M1 at the second iteration, again M2 at the third iteration, etc.), according to the second variant each iteration of the switching step 304 triggers the transmission of a single packet with its marking field MF set to a marking value (namely, M2) which is different from all the other preceding and subsequent packets Pk, whose marking fields MF are all set to M1.

The node 1 then waits a wait time whose duration is equal to the value stored in the local variable TW, namely the value V_{I} indicative of the measurement result available at the node 1 (step 305).

While the wait time is running, the node 1 preferably does not perform any further switching of its applicable marking value. Hence, according to the above mentioned first variant, during the wait time the node 1 continues to apply the marking value M2 to any packet Pk to be transmitted to the node 2. Besides, according to the above mentioned second variant, during the wait time the node 1 continues to apply the marking value M1 to any packet Pk to be transmitted to the node 2.

According to an embodiment, the node 1 may perform step 305 by starting a local timer counting the value stored in the local variable TW, and refraining from performing any further switching of its applicable marking value until the local timer is expired.

The local timer is preferably started by the node 1 upon transmission of the first packet Pk with marking value switched. Such transmission time may have a certain delay relative to the moment when the node 1 realizes that the local variable TW has become higher than 0 and has accordingly switched its applicable marking value, which delay depends on the packet transmission rate of the node 1.

Then, when the wait time lapses, the node 1 preferably reverts to step 304, thereby performing another switching of its applicable marking value.

Hence, according to a first variant, all the packets Pk transmitted following to this second iteration of the switching step 304 have their marking field MF set to the same marking value (namely, M1 at the second iteration of step 304), until the next iteration of step 304. According to a second variant, instead, after transmitting a single packet Pk with its marking field MF set to M2, the node 1 switches its applicable marking value back to M1.

The node 1 then performs another iteration of step 305, thereby starting another wait time whose duration is equal to the value stored in the local variable TW.

Also this further iteration of step 305 may be performed by using the above mentioned local timer, which is preferably started upon transmission of the first packet Pk with marking value switched. Again, such transmission time may have a certain delay relative to the moment when the node 1 realizes that preceding wait time is lapsed and has accordingly switched again its applicable marking value, which delay depends on the packet transmission rate of the node 1.

The above steps are iterated by the node 1, until the end of the measurement result transmission session (step 306). Hence, the node 1 basically performs one switching 304 of its applicable marking value every TW, which is equal to the value V_{I} indicative of the measurement result available at the node 1.

It shall be noticed that, while the above steps are iterated, the value of the local variable TW (and then the duration of the wait time) may dynamically vary in time. Specifically, if more measurements are performed by or provided to the node 1 (for example, the measurement is iterated to periodically monitor the performance of the node 1 or of the connection between the nodes 1 and 2 during its operation), then the value V_{I} is updated each time the measurement is iterated, and the value of the local variable TW is updated accordingly.

According to a variant, the node 1 keeps the value of the local variable TW fixed for the whole duration of the wait time. Then, upon expiry of the wait time the node 1 preferably checks if the value V_{I} has been updated during the wait time just ended and, in the affirmative, it writes the updated value V_{I} in the local variable TW. The updated value V_{I} written in the local variable TW will be then used to set the duration of the next wait time.

According to another variant, the node 1 may overwrite the value of the local variable TW as soon as it realizes that the value V_{I} has been updated, even if the current wait time is still ongoing. In this case, it may happen that the updated value V_{I} is lower than the time already expired since the beginning of the current wait time. This prevents the node 1 from ending the wait time in the proper way, namely in such a way that the wait time duration is equal to the value stored in the local variable TW. In order to obviate such drawback, the node 1 may force the duration of the current wait time to a predefined maximum duration Tmax, if it realizes that the updated value V_{I} is lower than the time already expired since the beginning of the current wait time. The maximum duration Tmax is preferably set much higher than a maximum value indicative of a maximum measurement result. For example, if the measurement is an RTT measurement and the value V_{I} is the measurement result itself (namely, the above-mentioned proportionality factor k is equal to 1), Tmax is set much higher than the maximum RTT between the nodes 1 and 2, for example Tmax=1 s.

This operation of the node 1 advantageously enables a probe placed on the path of the packets Pk to read the measurement result available at the node 1 in the packets Pk, as it will be discussed in detail herein below.

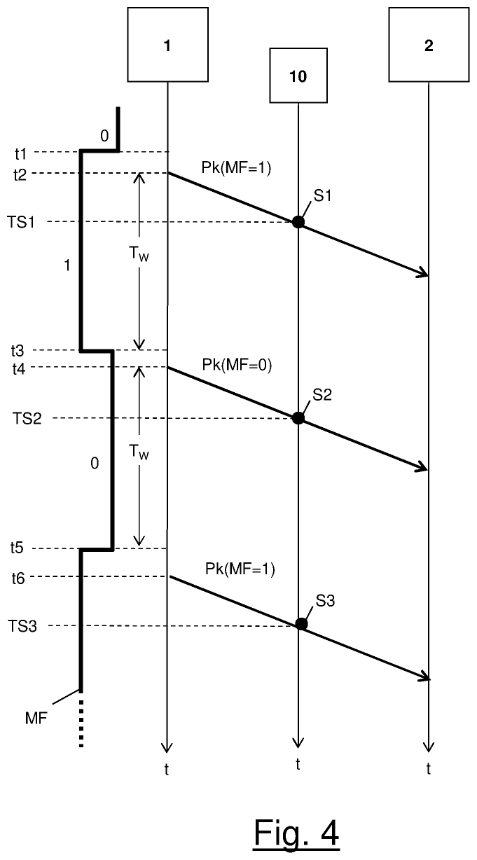

With reference to FIG. 4, it is assumed that the measurement result available at the node 1 is an RTT measurement result and that the marking field MF is a non-encrypted single-bit field switchable between M1=0 and M2=1. Further, FIG. 4 shows the operation of the node 1 according to the above mentioned first variant, whereby all the packets Pk transmitted by the first node 1 following to the switching step 304 have their marking field MF set to the same marking value, until the next iteration of step 304. In FIG. 4, for simplicity, only the first packet Pk transmitted following to each iteration of the switching step 304 is depicted.

The node 1 is initialized with its applicable marking value equal to M1=0 (step 301), and then transmits to the node 2 packets Pk with their marking field MF set to the marking value M1=0.

At time t1, the node 1 is provided with a first valid, non-zero RTT measurement result. The value V_{I} indicative of such RTT measurement result is then set equal to the RTT measurement result itself (identity relationship, as described above) and is then written in the local variable TW initialized to zero.

As it realizes that the value stored in the local variable TW is now higher than 0, the node 1 preferably switches its applicable marking value from M1=0 to M2=1 (step 304). The node 1 then starts transmitting to the node 2 packets Pk with their marking field MF set to the marking value M2=1. It may be appreciated that, as depicted in FIG. 4, the transmission time t2 of the first packet Pk having its marking field MF set to the marking value M2=1 is generally delayed relative to the time t1. The delay between t1 and t2 depends on the processing time at the node 1 and the packet transmission rate of the node 1.

Upon transmission of the first packet Pk having its marking field MF set to the marking value M2=1, the node 1 enters a wait time (step 305) whose duration is equal to the value stored in the local variable TW, during which it does not perform any further switching of its applicable marking value, thereby continuing to transmit packets Pk with their marking field MF set to the marking value M2=1. As discussed above, the node 1 preferably enters the wait time (for example, it starts the local timer counting the duration TW of the wait time) at the transmission time t2 of the first packet Pk having its marking field MF set to the marking value M2=1, so that the beginning of the wait time substantially coincides with the transmission time t2 of the first packet Pk having its marking value switched.

Then, at time t3 the wait time lapses, and then the node 1 preferably switches its applicable marking value back from M2=1 to M1=0 (step 304). The node 1 then starts transmitting to the node 2 packets Pk with their marking field MF set to the marking value M1=0. It may be appreciated that, as depicted in FIG. 4, the transmission time t4 of the first packet Pk having its marking field MF set to the marking value M1=0 is generally delayed relative to the time t3. Again, the delay between t3 and t4 depends on the processing time at the node 1 and the packet transmission rate of the node 1.

Upon transmission of the first packet Pk having its marking field MF set to the marking value M1=0, the node 1 enters again a wait time (step 305) whose duration is equal to the value stored in the local variable TW, during which it does not perform any further switching of its applicable marking value, thereby continuing to transmit packets Pk with their marking field MF set to the marking value M1=0. Again, as discussed above, the node 1 preferably enters the wait time (for example, it starts the local timer counting the duration TW of the wait time) at the transmission time t4 of the first packet Pk having its marking field MF set to the marking value M1=0, so that the beginning of the wait time substantially coincides with the transmission time t4 of the first packet Pk having its marking value switched.

It may be appreciated that the value stored in the local variable TW at this second iteration of step 305 may be different from that at the first iteration of step 305. In other words, the duration of the first wait time may be different from the duration of the second wait time. This may happen if the value of the local variable TW is updated between the end of the first wait time and the beginning of the second wait time, or during the second wait time (as described above, according to a variant the value of local variable TW may be overwritten as soon as an updated measurement result—and hence an updated value V_{I}—becomes available, even if the current wait time is still ongoing).

Then, at time t5 the second wait time lapses, and then the node 1 preferably switches its applicable marking value back from M1=0 to M2=1 (step 304). The node 1 then starts transmitting again to the node 2 packets Pk with their marking field MF set to the marking value M2=1. It may be appreciated that, as depicted in FIG. 4, the transmission time t6 of the first packet Pk having its marking field MF set to the marking value M2=1 is generally delayed relative to the time t5. Again, the delay between t5 and t6 depends on the processing time at the node 1 and the packet transmission rate of the node 1.

This operation of the node 1 may be further iterated, so that the switching of the applicable marking value upon lapse of a wait time of duration TW is further iterated by the node 1. In the meanwhile, the value stored in the local variable TW may be further updated, if in the meanwhile the RTT measurement available at the node 1 is further iterated.

This operation of the node 1 advantageously enables a probe placed on the path of the packets Pk to read the RTT measurement result available at the node 1 in the packets Pk transmitted from the node 1 to the node 2.

In the scenario of FIG. 4, it is assumed that a single probe 10 is placed on the path of the packets Pk. Assuming that the probe 10 is capable of detecting the packets Pk transmitted from the node 1 to the node 2 and to read the value of their marking fields MF as set by the node 1, at time TS1 the probe 10 detects the first switching S1 from M1 to M2 of the marking value applied by the node 1, at time TS2 it detects the second switching S2 from M2 to M1 of the marking value applied by the node 1, and at time TS3 it detects the third switching S3 from M1 to M2 of the marking value applied by the node 1.

The probe 10 may then obtain a sequence of readings V_{E} of the RTT measurement result available at the node 1, each reading V_{E} being obtained as the time lapsing between the detection of two consecutive switchings of the marking value as applied by the node 1. For example, a first reading V_{E} may be obtained by the probe 10 as a difference between TS2 and TS1, a second reading V_{E} may be obtained by the probe 10 as a difference between TS3 and TS2, and so on. In case the value V_{I} is related to the measurement result available at the node 1 by a mathematical relationship other than an identity relationship (which may be the case especially when the measurements results are of types other than RTT measurement results, as described above), the probe 10 shall apply an opposite mathematical relationship to the reading V_{E}, in order to obtain a reading of the measurement result available at the node 1 (and not of the value V_{I}).

Each reading V_{E} is then substantially equal to the value of the local variable TW (namely, to the value V_{I} indicative of the RTT measurement result available at the node 1) during the preceding wait time. It may be however appreciated that each reading V_{E} obtained by the probe 10 is affected by an error E relative to the value V_{I} indicative of the RTT measurement result available at the node 1, due to the fact that, as mentioned above, a delay may occur between lapse of a wait time and transmission of the next packet Pk, namely the first packet Pk with switched marking value. For example, as apparent also from FIG. 4, the first reading V_{E}=TS2−TS1 is equal to V_{I}+E, with E=t4−t3. Similarly, the second reading V_{E}=TS3−TS2 is equal to V_{I}+E, with E=t6−t5.

It may be appreciated that the error E decreases as the packet transmission rate of the node 1 increases. However, in case the packets Pk carry live traffic, their packet transmission rate typically fluctuates in an unpredictable way and may temporarily become very low or even zero. This ultimately results in an unpredictable error E on the reading V_{E} of the RTT measurement result available at the node 1 by the intermediate probe 10.

In order to enable the probe 10 to obtain more accurate reading V_{E} even when the packet transmission rate of the packets Pk fluctuates in an unpredictable way and temporarily becomes very low or even zero, according to an advantageous variant, when a wait time lapses, the node 1 preferably switches its applicable marking value only if it determines that the delay between lapse of the wait time and transmission of the next packet Pk does not exceed a predefined time threshold Eth. The predefined time threshold Eth may be e.g. of 1 ms. For example, with reference to FIG. 4, according to this variant the node 1 switches its applicable marking value from 1 to 0 only if the delay t4−t3 does not exceed the time threshold Eth. This guarantees that the reading V_{E} obtained by the probe 10 is affected by a predictable, maximum error E equal to Eth, irrespective of the unpredictable fluctuations of the transmission packet rate of the packets Pk.

If, instead, the delay t4−t3 exceeds the time threshold Eth, the node 1 preferably forces the duration of the current wait time to the above mentioned predefined maximum duration Tmax.

As mentioned above, Tmax is preferably selected much higher than the maximum value indicative of a maximum measurement result (for example, if the measurement is an RTT measurement and the value V_{I} is the measurement result itself, Tmax is set much higher than the maximum RTT between the nodes 1 and 2, for example Tmax=1 s). This way, the probe 10 may realize that the time lapsing between the detection times of the two consecutive switching S1 and S2 of the applicable marking value in the packets Pk is too high, and hence does not provide a reliable (and hence valid) reading V_{E} of the measurement result available at the node 1. For example, the probe 10 may consider a reading V_{E} valid only if it is lower than Tmax. Otherwise, if the reading V_{E} is greater than Tmax, then it is discarded (non-valid reading). Preferably, since the packets Pk may undergo jitter during their transmission, the probe 10 discriminates valid readings V_{E} and non-valid readings V_{E} by applying a threshold lower than Tmax, for example 95% Tmax.

According to an advantageously variant, the node 1 may dynamically vary the value of the time threshold Eth during the measurement session. For example, the node 1 may initially set the time threshold Eth to a maximum initial value Ethmax (e.g. 1 ms). Then, each time the condition on the time threshold Eth is met and the switching of the applicable marking value of the node 1 then properly operates, the node 1 decreases the value of the time threshold Eth. The value of the time threshold Eth may be decreased step-by-step from the maximum value Ethmax to a minimum value Ethmin. For this purpose, a number of predefined intermediate values comprised between Ethmin and Ethmax may be provided. Each time the condition on the time threshold Eth is met, the value of Eth is decreased by one step until, either the minimum value Ethmin is reached, or the condition on the time threshold Eth is not met anymore. In the latter case, the node 1 preferably increases the value of the time threshold Eth by one step and keeps it fixed.

Though in the above description it has been assumed that the node 1 marks the packets Pk to enable the probe 10 reading the measurement result available at the node 1 as described above, this is not limiting.

According to other embodiments, the node 2 may switch the marking value in the marking fields MF of the packets Pk′ to be transmitted to the node 1, to enable the probe 10 reading the measurement result available at the node 2. In this case, the operation of the node 2 may be the same as the operation of the node 1 described above with reference to the flow chart of FIG. 3. In this case, in order to read the measurement result available at the node 2, a probe shall be provided on the path of the packets Pk′, which is capable of detecting the packets Pk′ transmitted from the node 2 to the node 1 and to read the value of their marking fields MF as set by the node 2.

According to another embodiment, both the node 1 and the node 2 may switch the marking value in the marking fields MF of their outgoing packets Pk and Pk′. However, the node 1 and the node 2 operate independently of each other, namely the switching of the applicable marking value at the node 1 is not related to the switching of the applicable marking value at the node 2 and vice versa. If the probe is capable of detecting both the packets Pk transmitted from the node 1 to the node 2 and the packets Pk′ transmitted from the node 2 to the node 1, the probe 10 may obtain readings of the measurement results available at the node 1 or 2 from either the packets Pk or the packets Pk′.

According to other embodiments, the marking field MF may comprise more than 1 bit, so that more than two marking values may be applied to the packets Pk. For example, the marking values may be applied by the node 1 according to a predefined sequence (e.g. “00”, “01”, “10” and “11”, in case of two bits) which is repeated cyclically. This for example allows the probe 10 to detect “missing” wait times, which might be due to a packet loss involving all the packets Pk transmitted by the node 1 during a certain wait time. Such an event is of course more likely when a single packet Pk (or few packets Pk) is transmitted during a wait time, such as variant whereby a single packet Pk with switched marking value M2 is transmitted each time a wait time lapses.

1. A method for transmitting through a packet-switched communication network a measurement result available at a node of said packet-switched communication network, said node applying a marking value to packets of a packet flow to be transmitted to a further node of said packet-switched communication network, said marking value being switchable by said node between at least two alternative marking values, said method comprising, by said node:
a) performing a switching of said marking value applied to packets of said packet flow to be transmitted to said further node;
b) waiting a wait time whose duration is equal to a value indicative of said measurement result available at said node; and
c) performing a further switching of said marking value applied to packets of said packet flow to be transmitted to said further node.

2. The method according to claim 1, wherein said value indicative of said measurement result available at said node is equal to a round-trip time measurement result available at said node.

3. The method according to claim 1, wherein step a) is performed when a first valid, non-zero measurement result is available at said node, and wherein steps b) and c) are cyclically iterated after step a) has been performed.

4. The method according to claim 1, wherein said wait time is started when a first packet of said packet flow following to said switching at step a) is transmitted to said further node.

5. The method according to claim 1, wherein said value indicative of said measurement result available at said node is updated during step b) into an updated value indicative of an updated measurement result available at said node.

6. The method according to claim 5, wherein at step b) said duration of said wait time is kept equal to said stored value until lapse of said wait time, said updated value being applied at a subsequent iteration of step b).

7. The method according to claim 5, wherein at step b) said duration of said wait time is changed into said updated value while said wait time is ongoing.

8. The method according to claim 1, wherein said further switching at step c) comprises switching said marking value applied to packets of said packet flow to be transmitted to said further node only if a time lapsing between lapse of said wait time and subsequent transmission of a packet of said packet flow to said further node does not exceed a predefined time threshold [[(Eth).

9. The method according to claim 1, wherein said further switching at step c) comprises forcing said further switching of said marking value applied to packets of said packet flow to be transmitted to said further node when a maximum time has lapsed since said switching at step a).

10. The method according to claim 9, wherein said maximum time is higher than a maximum value indicative of a maximum measurement result.

11. The method according to claim 1, wherein step a) comprises, after said switching, keeping said marking value applied to packets of said packet flow to be transmitted to said further node fixed, until said wait time is lapsed.

12. The method according to claim 1, wherein step a) comprises, after said switching, transmitting one packet of said packet flow to said further node, switching again said marking value applied to packets of said packet flow to be transmitted to said further node and keeping said marking value applied to packets of said packet flow to be transmitted to said further node fixed, until said wait time is lapsed.

13. A method for reading a measurement result available at a node of a packet-switched communication network and transmitted through said packet-switched communication network, said method comprising the steps of the method according to claim 1 and:
d) by a probe placed on a path of said packet flow, detecting a first switching and a second switching of the marking value applied to packets of said packet flow transmitted by said node to said further node and obtaining a reading of said measurement result available at said node as a time lapsing between said first switching and said second switching.

14. The method according to claim 9, wherein said step d) comprises discarding said reading if it is determined that said reading is not lower than said maximum time.

15. A node for a packet-switched communication network, said node being configured to transmit a packet flow to a further node of said packet-switched communication network, said node being configured to apply a marking value to packets of said packet flow to be transmitted to said further node, said marking value being switchable by said node between at least two alternative marking values, said node being configured to:
a) perform a switching of said marking value applied to packets of said packet flow to be transmitted to said further node;
b) wait a wait time whose duration is equal to a value indicative of a measurement result available at said node; and
c) perform a further switching of said marking value applied to packets of said packet flow to be transmitted to said further node.

16. A packet-switched communication network comprising a node and a further node, said node being configured to transmit a packet flow to said further node, said node being according to claim 15.

17. The packet-switched communication network of claim 16, further comprising a probe placed on a path of said packet flow, said probe being configured to:
d) detect a first switching and a second switching of the marking value applied to packets of said packet flow transmitted by said node to said further node and obtaining a reading of said measurement result available at said node as a time lapsing between said first switching and said second switching.
